(19) United States
(12) Patent Application Publication
(10) Pub. No.: US 2005/0194202 A1
(43) Pub. Date: Sep. 8, 2005

(54) Speaker insulator and a speaker apparatus

(75) Inventor: Takeshi Ito, Tendo-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION and TOHOKU PIONEER CORPORATION

(21) Appl. No.: 11/047,739

(22) Filed: Feb. 2, 2005

(30) Foreign Application Priority Data
Feb. 3, 2004 (JP) J2004-26371

(51) Int. Cl. H04R 7/00; G10K 13/00

(52) U.S. Cl. 181/166

(57) ABSTRACT

The speaker apparatus has a speaker installed on an inner panel through an insulator. The insulator is provided with: an elastic member which absorbs vibrations generated from the speaker; one supporting panel which is fixed on the elastic member and installed on the speaker; and another supporting panel which is fixed on the opposite side of the elastic member side where the one supporting panel is fixed, and installed on the inner panel. The two supporting panels are glued on both sides of the elastic member.

### BACKGROUND OF THE INVENTION

1. Field of the Invention

The present invention relates to a speaker insulator and a speaker apparatus, and more particularly, to a speaker insulator and a speaker apparatus adopted as a car speaker.

2. Related Art

Japanese Utility Model Application Laid-Open Publication No. Hei. 06-003746 discloses, for example, the door inner panel 9 and the cushion 12 in FIG. 2, that a conventional speaker apparatus is installed on the inner panel of the inside of a car door through cushion materials so that propagation of vibrations is damped.

However, in the above-described technology, a cushion is provided between a door inner panel, which corresponds to an inner panel of the present invention, and a supporting flange, but the door inner panel and the supporting flange are rigidly fixed by using bolts. Therefore, the cushion cannot isolate the propagation of vibrations, and the vibrations of a speaker unit propagate to the door inner panel through the bolts, resulting in vibration of the door inner panel. In particular, in the case of a car speaker apparatus, for example, since an inner panel having sufficient rigidity cannot be adopted because of the requirement of light weight, the inner panel itself vibrates and generates sounds due to propagated vibrations, and there is a problem to give listeners a distorted feeling or an uneasy feeling of sounds.

### SUMMARY OF THE INVENTION

An object of the present invention is to provide a speaker insulator or a speaker apparatus which does not give a distorted feeling or an uneasy feeling of sounds by isolating vibrations of an inner panel induced by vibrations of a speaker unit, or by attenuating or preventing the propagation of vibrations of a speaker unit to the inner panel.

The present invention will be described below. Although reference numerals in the accompanying drawings will be accessorily written as parenthetic numerals for descriptive convenience, the present invention is not limited to the illustrated features.

The above object of the present invention can be achieved by a speaker insulator (2) installed between a speaker unit (3) and an inner panel (1), the speaker insulator (2) provided with: a vibration absorbent member (6) which absorbs vibrations generated from the speaker unit (3); a first supporting member (7) which is fixed on the vibration absorbent member (6) and installed on the speaker unit (3); and a second supporting member (8) which is fixed on the opposite side of the vibration absorbent member side where the first supporting member (7) is fixed, and installed on the inner panel (1).

The above object of the present invention can be achieved by a speaker apparatus (SP) having a speaker unit (3) installed on an inner panel (1) through a speaker insulator (2), the speaker insulator (2) provided with: a vibration absorbent member (6) which absorbs vibrations generated from the speaker unit (3); a first supporting member (7) which is fixed on the vibration absorbent member (6) and installed on the speaker unit (3); and a second supporting member (8) which is fixed on the opposite side of the vibration absorbent member side where the first supporting member (7) is fixed, and installed on the inner panel (1).

The nature, utility, and further features of this invention will be more clearly apparent from the following detailed description with respect to preferred embodiments of the invention when read in conjunction with the accompanying drawings briefly described below.

### BRIEF DESCRIPTION OF THE DRAWINGS

FIG. 1 shows a diagram of a partial cross section of a car speaker apparatus SP in accordance with one embodiment of the present invention;

FIG. 2 shows a cross sectional view of an insulator 2 in accordance with one embodiment of the present invention;

FIG. 3 shows a perspective view in which the insulator 2 is installed on a speaker 3 in accordance with one embodiment of the present invention;

FIG. 4 shows a drawing of points used for measurement when a trial product of a car speaker apparatus SP in accordance with one embodiment of the present invention was experimentally manufactured;

FIGS. 5A and 5B show measurement results when the trial product of the car speaker apparatus SP in accordance with one embodiment of the present invention was constructed: FIG. 5A shows measurement results of a cone-type speaker and FIG. 5B shows measurement results of a vibration-type speaker;

FIG. 6 shows a drawing of a modified example of the insulator 2 in accordance with one embodiment of the present invention; and

FIG. 7 shows a drawing of another modified example of the insulator 2 in accordance with one embodiment of the present invention.

### DESCRIPTION OF THE PREFERRED EMBODIMENT

Hereinafter, one embodiment of a speaker apparatus according to the present invention will be explained by using a car speaker apparatus installed at a door panel as an example with reference to the drawings.

In general, a door panel of a car is composed of a double layer structure in order to store a window glass and its lifting mechanism. Further, the inner panel of the double layer structure is equipped with a car inner panel supporting a window glass lifting mechanism to lift or lower the window glass. The outer panel of the double layer structure comprises an outer panel at the outside of the car and a door trim at the car room side (inside cover).

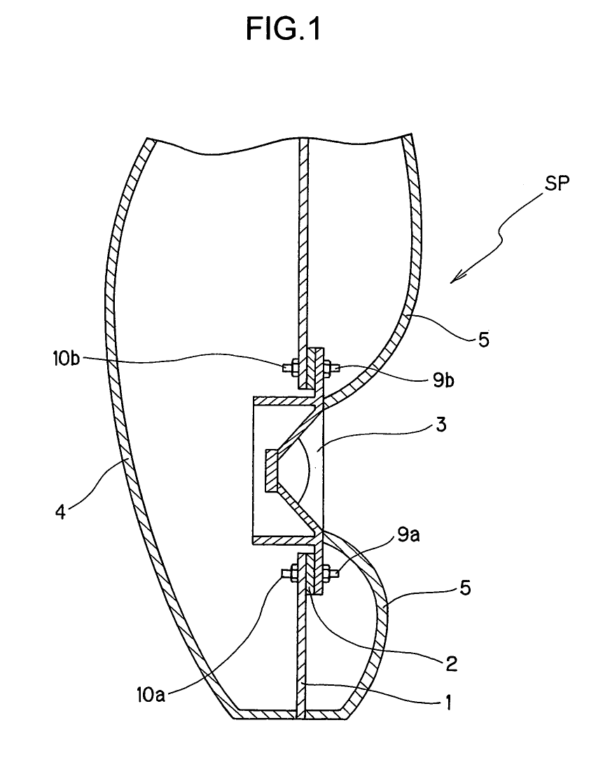

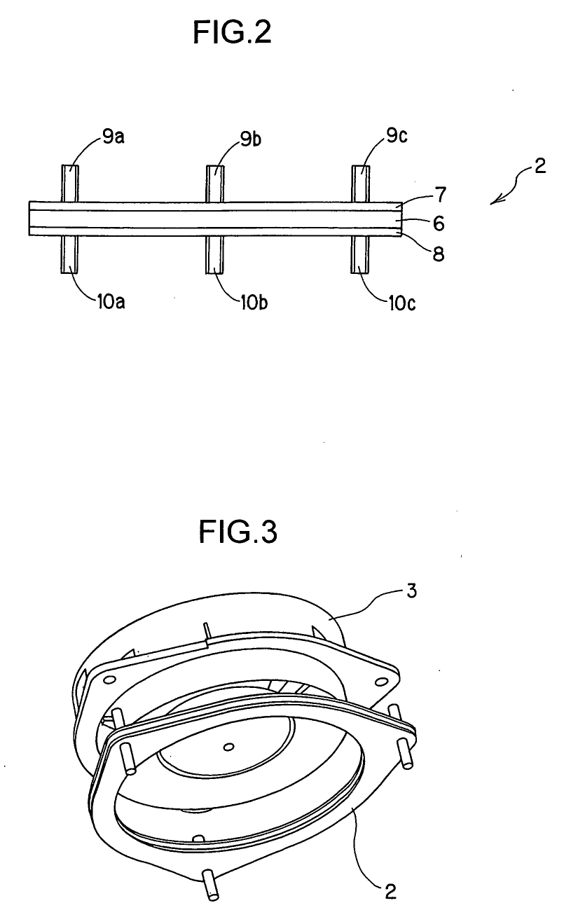

FIG. 1 shows a partial cross section view of a car speaker apparatus SP in accordance with one embodiment of the present invention, FIG. 2 shows a cross sectional view of an insulator in accordance with one embodiment of the present invention, and FIG. 3 shows a perspective view when the insulator 2 is installed in a speaker 3 in accordance with one embodiment of the present invention.

The car speaker apparatus SP shown in FIG. 1 has a structure in which the speaker 3 is installed into an inner panel 1 through the insulator 2. A cat door panel having a double layer structure is formed by sandwiching the inner panel 1 with an outer panel 4 provided at the outside of the car and an inner trim 5 provided at the inside of the car.

The inner panel 1 can be manufactured by, for example, press molding of steel sheets etc. or integrally molding of composite resins such as resins, FRP (fiberglass reinforced plastics), etc.

The outer panel 4 can be manufactured by, for example, press molding of steel sheets etc.

The inner trim 5 can be manufactured by, for example, integrally molding of composite resins such as resins, FRP, etc.

Next, the structure of the insulator 2 will be explained in reference to FIG. 2 and FIG. 3.

The insulator 2 comprises an elastic member 6 which absorbs vibrations generated by the speaker 3 and supporting panels 7 and 8 which are fixed on both sides of the elastic member 6.

The elastic member 6 can be manufactured by using elastic materials such as silicone rubber etc., for example. It has the same size and shape as those of the flange portion of the speaker 3 and has a sufficient thickness to absorb vibrations generated by the speaker 3.

The supporting panels 7 and 8 are manufactured from, for example, cold-rolled steel sheets or hard resins or the like, and glued on both sides of the elastic member 6 with, for, example, adhesives. In addition, the two supporting panels 7 and 8 do not make contact with each other. Further, at the positions corresponding to the installation positions of the speaker 3 and the inner panel 1, there are provided anchor bolts 9a, 9b, 9c, 10a, 10b, and 10c which are vertically arranged.

As the anchor bolts 9a, 9b, 9c, 10a, 10b, and 10c, for example, all-purpose welding studs etc. are used. The anchor bolts 9a, 9b, and 9c erected on the support panel 7 and the anchor bolts 10a, 10b, and 10c erected on the supporting panel 8, between which the elastic member 6 is sandwiched, do not make contact with each other.

Here, for example, the car speaker apparatus SP according to the present embodiment constitutes the speaker apparatus of the present invention; the inner panel 1 constitutes the inner panel of the present invention; the insulator 2 constitutes the speaker insulator of the present invention; the speaker 3 constitutes the speaker unit; the elastic member 6 constitutes the vibration absorbent member of the present invention; the supporting panels 7 and 8 constitute respectively the first supporting member and the second supporting member of the present invention; and the anchor bolts 9a, 9b, 9c, 10a, 10b, and 10c constitute the first installation portion and the second installation portion of the present invention and the first bolts and the second bolts of the present invention.

The physical phenomenon regarding sounds which the car speaker apparatus SP having the structure described above generates will be explained below.

When the speaker 3 generates sounds after receiving sound signals, the speaker 3 itself vibrates with vibrations of a diaphragm inside the speaker 3. This vibration is subjected to the propagation to the inner panel 1 through the flange portion of the speaker 3, but since the insulator 2 is provided between the speaker 3 and the inner panel 1, the vibration energy that propagates to the inner panel 1 is attenuated by the insulator 2. As a result, the vibration of the inner panel 1 itself is attenuated and noises generated are also attenuated. Accordingly, a distorted feeling or an uneasy feeling of sounds for passengers including a driver can be suppressed.

Further, the output and characteristics of the speaker 3, and raw materials, thickness, size, shape, etc. of the inner panel 1 depend on types of cars, and the propagation of vibrations also depends on the situation. Therefore, the thickness of the elastic member 6, and the arrangement, the number etc. of the anchor bolts 9a, 9b, 9c, 10a, 10b, and 10c are determined experimentally for individual types of cars.

### Embodiment

Effects of the present invention will be explained by using data measured for a car speaker apparatus SP manufactured as a prototype according to the present embodiment.

(Measurement Condition)

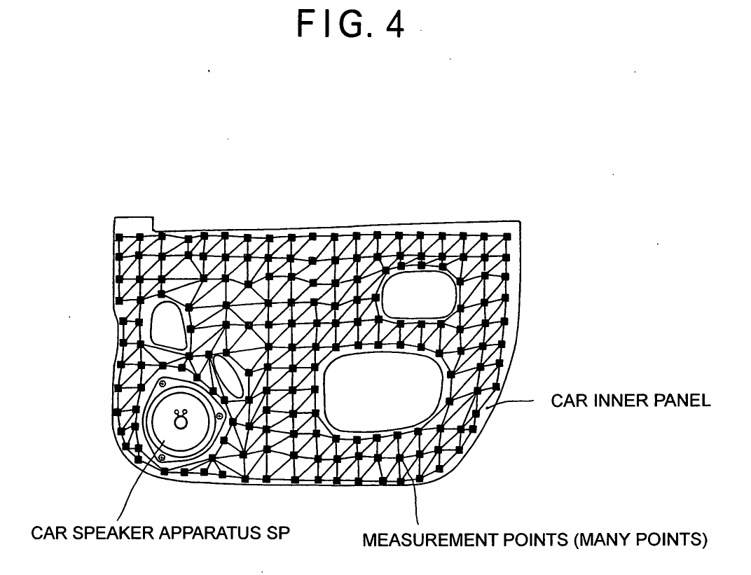

A car speaker apparatus SP was manufactured by using an actual car inner panel and fixed on a rigid stand. When sine waves were inputted into the speaker as measuring signals, the vibration acceleration of the inner panel due to speaker vibrations was measured with a laser Doppler vibrometer. FIG. 4 shows measurement points used in the test. Speakers used in the measurement were a vibration-type speaker in addition to an ordinary cone-type speaker, and an insulator used for each of the two speakers was identical. In addition, as a comparison experiment, a speaker without having the insulator 2 was fixed directly on the inner panel with bolts and a measurement was performed.

Here, the vibration-type speaker refers to a speaker manufactured by moving the net mass of the cone and the center cap portion to the top portion of the voice coil, and it was manufactured with the purpose of excluding the effect of back pressure as much as possible. This type of speakers was disclosed, for example, in FIG. 3 of Japanese Patent Publication Laid-Open No. H11-27784.

(Measured Results)

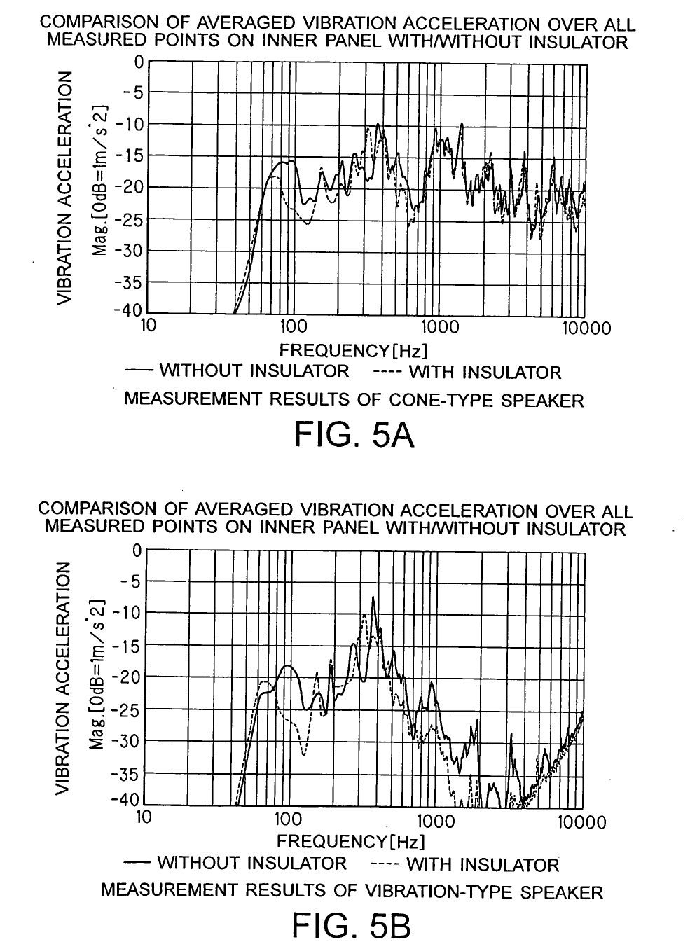

FIGS. 5A and 5B show measured results of each of the two speakers after averaging vibration acceleration data over all the measured points. The measured data of both the cone-type speaker (FIG. 5A) and the vibration-type speaker (FIG. 5B) show more attenuation effects for vibration acceleration in the case where the insulator was installed, in the vicinity of 100 Hz, more specifically in the low frequency range from 70 to 130 Hz. Since rattle sounds due to inner panel vibrations are known to be large in this low frequency range, it is confirmed that the installation of the insulator is effective to reduce rattle sounds.

In addition, in the vibration-type speaker (FIG. 5B), it is verified that the attenuation effects for vibration acceleration were also obtained in the frequency range from 800 to 2,000 Hz.

The present embodiment has the following effects.

Since the speaker 3 and the inner panel 1 are installed through the insulator 2, the vibration energy of the speaker 3, associated with sound generation, is attenuated with the insulator 2. Thus, noises due to vibrations of the inner panel 1 itself are reduced, and a distorted feeling or an uneasy feeling of sounds for listeners can be suppressed. In particular, vibration attenuation effects are large in the low frequency range where the vibration of the inner panel 1 is a source of rattle sounds, and the effect for suppressing a distorted feeling or an uneasy feeling of sounds for listeners is large.

Since the elastic member 6 and the supporting panels 7 and 8 are assembled as a single piece, component management is easy and installation operation can be performed efficiently.

In the insulator 2, since the anchor bolts 9a, 9b, and 9c, and the anchor bolts 10a, 10b, and 10c, each placed at the corresponding position, are provided respectively on the supporting panels 7 and 8 by sandwiching the elastic member 6 and do not make contact with each other, the vibration energy of the speaker 3, associated with sound generation, is definitely attenuated with the insulator 2.

Since the elastic member 6 has the same size and shape as those of the flange portion of the speaker 3, the vibration energy of the speaker 3 is definitely attenuated with the insulator 2.

The thickness of the elastic member 6 can be adjusted in accordance with the output of the speaker 3 and the vibration energy generated by the speaker 3, and thus the attenuation effect can be adjusted.

Since the elastic member 6 and the anchor bolts 9a, 9b, 9c, 10a, 10b, and 10c of the supporting panels 7 and 8 are assembled as a single piece, component management is easy and installation operation can be performed efficiently.

Since the elastic member 6 is sandwiched between the supporting panels 7 and 8, the strength of the insulator 2 can be guaranteed.

Furthermore, the embodiment is not limited to the above-described embodiment, and it can be modified, for example, as described below.

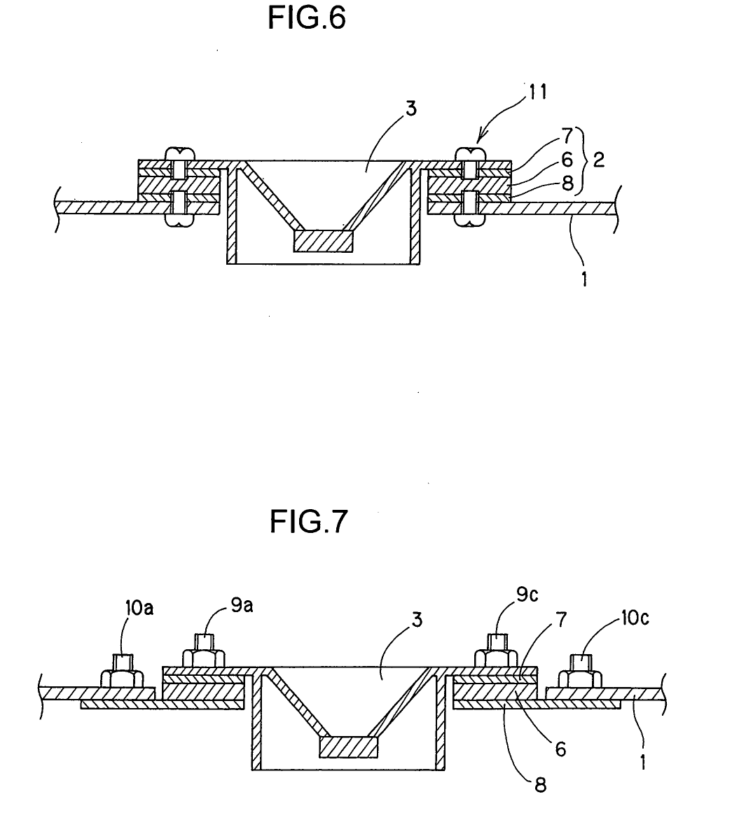

In the above-described embodiment, the insulator 2 is mounted with the anchor bolts 9a, 9b, 9c, 10a, 10b, and 10c of the supporting panels 7 and 8, but, as shown in FIG. 6, female threads 11 may be provided as an example of the supporting portion at the supporting panel locations corresponding to the installation position of the speaker and the inner panel, and bolts or male screws may be used for fixing the speakers 3 or the inner panel 1. The workability of installation may be better.

In one embodiment described above (particularly in FIG. 3), the positions of the anchor bolts of the two supporting panels 7 and 8 are the same, but the arrangement is not limited to this. The positions of the anchor bolts of the two supporting panels may be different each other. The installation positions may be changed in accordance with the vibration attenuation effect depending on the shapes and installation positions of the speaker and the inner panel. In addition, as shown in FIG. 7, by changing the size of the two supporting panels and by changing the direction of installation of the anchor bolts, the thickness of the car speaker apparatus SP can be made thin and thus the degree of freedom during the shape design stage of the insulator can be increased. Furthermore, either one of the installation portion provided on the two supporting panels 7 and 8 may use anchor bolts and the other side may use female screws.

Further, when female screws are used at the installation portion as shown in the above-described modified example, if screw holes (installation positions) are provided at different positions at the two supporting panels, the installation screws of the speaker side do not bump those on the inner panel side, and thus the degree of freedom during the shape design stage of the insulator is increased.

In the above-described embodiment, the present invention was explained by using an example of the car speaker apparatus SP, but the present invention is not limited to this. For example, the present invention can be applied to the position where vibrations generated by a speaker apparatus SP become problematic in case the portion of the installation panel such as rear panels etc. does not have sufficient rigidity. Furthermore, the present invention can be applied to the structure in which a speaker can be installed on the inner panel, for example, the panel of a motorcycle or the door panel of a moving body such as the door panel of a boat etc.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-26371 filed on Feb. 3, 2004 including the specification, claims, drawings and summary is incorporated herein by reference in its entirety.

1. A speaker insulator installed between a speaker unit and an inner panel, the speaker insulator comprising:
a vibration absorbent member which absorbs vibrations generated from the speaker unit;
a first supporting member which is fixed on the vibration absorbent member and installed on the speaker unit; and
a second supporting member which is fixed on the opposite side of the vibration absorbent member side where the first supporting member is fixed, and installed on the inner panel.

2. The speaker insulator according to claim 1, wherein
the first supporting member has a first installation portion which is used when installed to the speaker unit, and
the second supporting member has a second installation portion which is used when installed to the inner panel.

3. The speaker insulator according to claim 2, wherein
the first installation portion is a first bolt which is used for the installation of the speaker unit, and
the second installation portion is a second bolt which is used for the installation of the inner panel.

4. The speaker insulator according to claim 3, wherein the first bolt and the second bolt are isolated by sandwiching the vibration absorbent member.

5. The speaker insulator according to claim 2, wherein at least one portion of the first installation portion and the second installation portion has female threads.

6. The speaker insulator according to claim 1, wherein the vibration absorbent member has the same shape as that of a flange portion of the speaker unit.

7. A speaker apparatus having a speaker unit installed on an inner panel through a speaker insulator, the speaker insulator comprising:
a vibration absorbent member which absorbs vibrations generated from the speaker unit;
a first supporting member which is fixed on the vibration absorbent member and installed on the speaker unit; and
a second supporting member which is fixed on the opposite side of the vibration absorbent member side where the first supporting member is fixed, and installed on the inner panel.
